(19) United States
(12) Patent Application Publication
(10) Pub. No.: US 2005/0244545 A1
(43) Pub. Date: Nov. 3, 2005

(54) Depositor pump, having a modular valve apparatus, for manufacturing starch molded products such as candy

(75) Inventor: John Akelaitis, Loves Park, IL (US)

Correspondence Address: REINHART BOERNER VAN DEUREN LTD., 483 NORTH MULFORD ROAD, SUITE 7, ROCKFORD, IL, 61107, US

(73) Assignee: Liberty Engineering Company, Roscoe, IL (US)

(21) Appl. No.: 10/833,698

(22) Filed: Apr. 28, 2004

(51) Int. Cl. A23G 1/00; B67D 5/62

(52) U.S. Cl. 426/103; 222/146.2

(57) ABSTRACT

A depositor pump, includes a pump body, and a modular valve apparatus operatively attached to the pump body. The modular valve apparatus includes a valve guide apparatus attached to the pump body, and defining a slot therein for receiving a valve bar adapted for sliding operation within the slot. The modular valve apparatus also defines a pump inlet in fluid communication with the slot of the valve guide apparatus. The modular valve apparatus also includes removable cylinders and a removable cylinder support plate, so that all components of the pump which come into contact with the media being pumped can be replaced without machining of any component of the pump.

### FIELD OF THE INVENTION

The present invention relates generally to the art of food manufacturing, and more particularly to pumps used in depositor machines, also commonly known as mogul machines, for manufacturing starch molded products.

### BACKGROUND OF THE INVENTION

Mogul machines have been used for many years in the manufacture of starch molded products such as pectin, galantine, agar, agar-based jellies, gummies, liquorice, fondant, cream, marshmallow foam, and other similar materials. Many of these products are commonly referred to as candy. Mogul machines may also be used for depositing liqueur inside of candy shells.

The typical process for making these forms of candy or other starch molded products includes dumping starch into trays, stamping cavities in the starch, pumping a liquefied candy mixture into the cavities, curing of the candy to allow it to sufficiently harden (e.g. drying), and then separating the candy from the starch.

A depositor pump is used for pumping the liquefied candy mixture into the cavities in the starch. FIGS. 1 through 3 show various aspects of one commonly used form of a depositor pump 10, having an inlet 12 that is adapted for attachment thereto of hopper 14, having an opening 15 for receiving the liquefied candy mixture. The pump 10 includes a housing 16, having a pump body section 18, and an L-shaped valve guide section 20, which are bolted together to form the housing 16, and to define a longitudinally extending rectangular shaped slot 22 in the housing 16 for receiving a movable valve bar 24.

The pump 16 typically includes more than 100 pistons 26 mounted in cylinder bores 28 of cylinders 29 that are in turn attached to the pump body 18. The lower leg 30 of the L-shaped valve guide section 20 of the pump housing 16 defines a large number of outlet orifices 31, for delivering measured portions of the liquefied candy mixture, through nozzles 32 in a nozzle plate 33 attached to the lower leg 30, into cavities 34 in the starch filled trays 36, which are positioned under the pump 16, manually, or by a transport device such as a conveyor belt (not shown).

The valve bar 24 includes a large number of internal passageways, which are arranged in longitudinally offset arrays, as shown in FIG. 3, for receiving the liquefied candy mixture, as indicated at 37, and directing it along either a first path 38 from the inlet 12 to the cylinder bores 28, or a second path 40 from the cylinder bores 28 to the nozzles 32, depending upon whether the valve bar 24 is located in a first or a second position in the longitudinally extending rectangular shaped slot 22 in the housing 16. The valve bar 24 is shuttled between the first and second positions, and the pistons are reciprocated in unison in the cylinder bores 28, in a timed relationship, such that when the valve bar 24 is in the first position, a measured amount of liquefied candy mixture can be drawn into each of the cylinder bores 28 from the inlet 12, along the first path 38 through one set of internal passageways in the valve bar 24, by an upward motion of the pistons 26.

With the valve bar 24 in the first position, the valve bar 24 cuts off any fluid communication between the cylinder bores 28 and the outlet orifices 31. Once the desired amount of liquefied candy has been drawn into the cylinder bores 28, the valve bar 24 is shuttled to the second position.

In the second position, the valve bar 24 cuts off fluid communication between the inlet 12 and the cylinder bores 28, so that no further liquefied candy mixture can enter the cylinder bores 28 from the inlet 12, and so that the liquefied candy mixture in the cylinder bores 28 cannot flow back out through the inlet 12. The second set of internal passageways 40 in the valve bar 24, provides fluid communication between the cylinder bores 28 and the outlet orifices 31. With the valve bar 24 in the second position, the pistons 26 are moved downward in the cylinder bores 28 to force the measured amounts of liquefied candy in the cylinder bores 28 out through the outlet orifices 31, nozzle plate 33 and nozzles 32, into the cavities 34 in the starch mixture in the tray 36 positioned under the pump 10.

In order for the valve bar 24 to properly perform its function, it must fit snuggly into the longitudinally extending slot 22 in the housing 16. It will be appreciated that in large volume production of candy, the valve bar 24 is shuttled many thousands of times, and that over time, the mating surfaces of the valve bar 24 and the slot 22 become worn to the point that the valve bar 24 cannot properly perform its function of directing and cutting off a flow of the liquefied candy mixture, and the pump 10 must be refurbished to restore the proper fit between the mating surfaces of the valve bar 24 and the slot 22.

In the past, the construction of the pump housing 16 has made initial construction and refurbishing a worn pump 10 difficult. The pump body 18 has typically been made from a single casting. Pump bodies 18 tend to be rather large and heavy, for example two to three feet in length, to accommodate the several hundred pistons 26 required to achieve high volume production rates required for making candy.

The size and shape of the pump body 18 and L-shaped valve guide 20 make it difficult to achieve the tight tolerances required on the dimensions of the longitudinally extending slot 22 in a housing 16 formed by bolting together the pump body 18 and L-shaped valve guide 20. In the past, this has required that the valve bar 24 for each pump 10 be essentially custom fitted to operate properly in the slot 22, during both initial construction and refurbishment of the pump 10.

It is desirable to provide an improved pump, for a depositor machine, that can be more readily manufactured and refurbished.

### BRIEF SUMMARY OF THE INVENTION

The invention provides an improved pump for a depositor machine, through the use of a modular valve apparatus that is adapted for attachment to a pump body of a depositor pump.

One form of the modular valve apparatus includes, a valve guide apparatus adapted for attachment to the pump body and defining a slot therein for receiving a valve bar; and a valve bar adapted for sliding operation within the slot. The modular valve apparatus may also define a pump inlet in fluid communication with the slot of the valve guide apparatus.

One form of the valve guide apparatus includes an upper guide plate and an inlet manifold attached to the pump body, a side rail attached to the upper guide plate, and a lower guide plate attached to the inlet manifold and the side rail, with the upper and lower guide plates, the side rail, and the inlet manifold, in combination, defining the slot for receiving a valve bar.

The modular valve apparatus may also include one or more cylinders having a lower end configured for engaging the upper guide plate, and a removable cylinder support plate for attaching the upper end of the cylinder to the pump body, so that all of the components of the pump which are exposed to the pumped medium can be readily fabricated and installed during initial manufacture of the pump, and replaced during refurbishment.

The invention may also take the form of a depositor pump, including a pump body, and a modular valve apparatus operatively attached to the pump body, with the modular valve apparatus including a valve guide apparatus attached to the pump body, and defining a slot therein for receiving a valve bar.

Other objectives and advantages of the invention will become more apparent from the following detailed description and accompanying drawings.

### BRIEF DESCRIPTION OF THE DRAWINGS

FIG. 1 is a partially exploded perspective view of a prior depositor pump;

FIG. 2 is cross sectional view of the prior depositor pump of FIG. 1;

FIG. 3 is a cross sectional view, taken along lines 3-3 in FIG. 1, of the valve bar of the prior depositor pump shown in FIG. 1.

FIG. 4 a partially exploded perspective view of a depositor pump, according to the invention;

FIG. 5 is cross sectional view of the depositor pump, according to the invention, of FIG. 1;

FIG. 6 is a cross sectional view, taken along lines 6-6 in FIG. 4, of the valve bar of the depositor pump, according to the invention, as shown in FIG. 4;

FIG. 7 is a partially exploded view of an exemplary embodiment of a modular valve apparatus, according to the invention, for the depositor pump shown in FIGS. 4-6, 8, and 9;

FIG. 8 is a cross sectional view of the exemplary embodiment of the depositor pump, shown in FIGS. 4-7, with the valve bar in a first position and the pistons moving upward to draw a measured amount of liquefied candy mixture into each of the cylinder bores; and

FIG. 9 is a cross sectional view of the exemplary embodiment of the depositor pump, shown in FIGS. 4-7, with the valve bar in a second position and the pistons moving downward and expelling the measured amounts of liquid candy in the cylinder bores through nozzles in a nozzle plate attached to a modular valve apparatus, according to the invention.

While the invention will be described in reference to certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

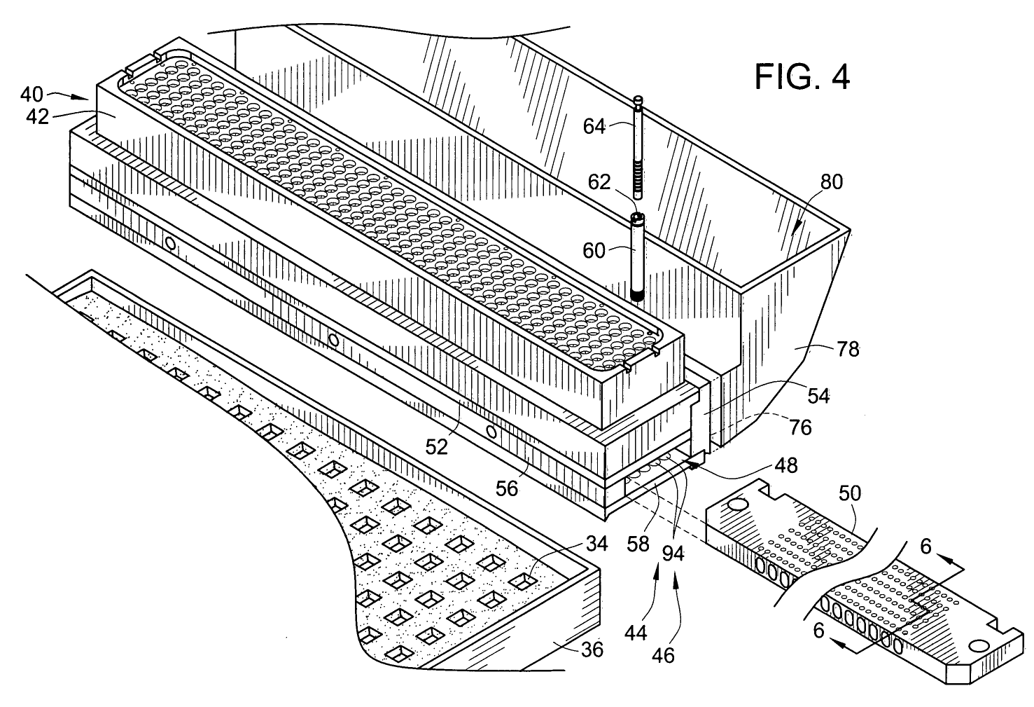

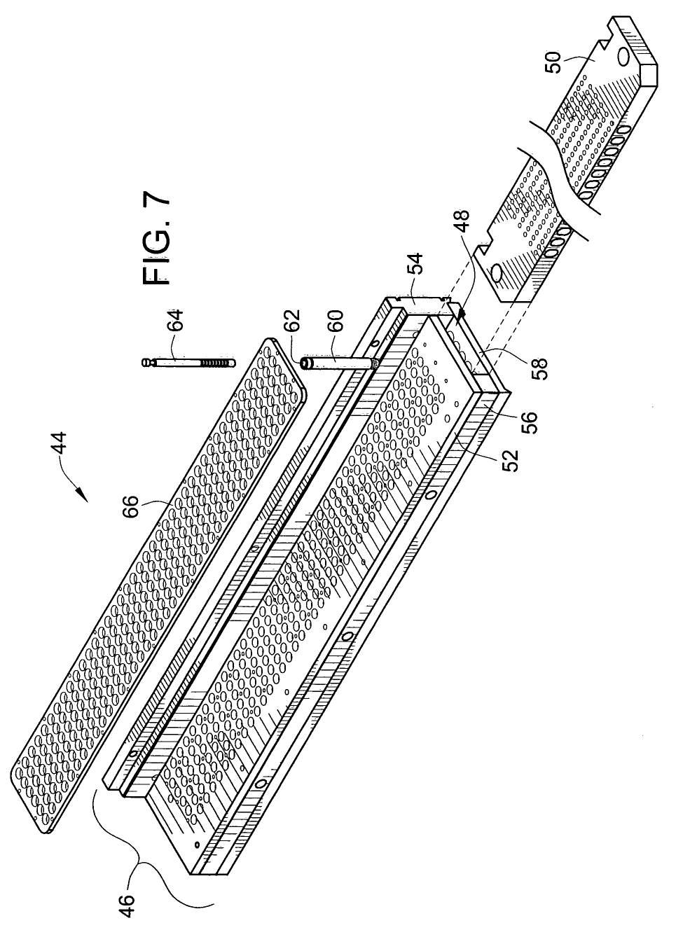

As shown in FIGS. 4-7, an exemplary embodiment of a depositor pump 40 includes a pump body 42, and a modular valve apparatus 44 (shown in an exploded view in FIG. 7) operatively attached to the pump body 42.

The modular valve apparatus 44 includes a valve bar 50 and a valve guide apparatus 46 that is adapted for attachment to the pump body 42, and defines a slot 48 therein for receiving the valve bar 50. The modular valve apparatus 44 of the exemplary embodiment also includes a plurality of cylinders 60 each having an internal bore 62 for receiving a piston 64, and a removable cylinder support plate 66.

The valve guide apparatus 46 includes, an upper guide plate 52 and an inlet manifold 54 attached to the pump body 42, a side rail 56 attached to the upper guide plate 52, and a lower guide plate 58 attached to the inlet manifold 54 and the side rail 56. The upper and lower guide plates 52, 58, the side rail 56, and the inlet manifold 54, in combination, define the slot 48 for receiving a valve bar 50, and are attached to one another, and to the pump body 42, by bolts 68, 70, 72 and pins 74, 75, 77. The inlet manifold 54 also defines an inlet 76 that is adapted for attachment thereto of hopper 78, having an opening 80 for receiving a liquefied candy mixture.

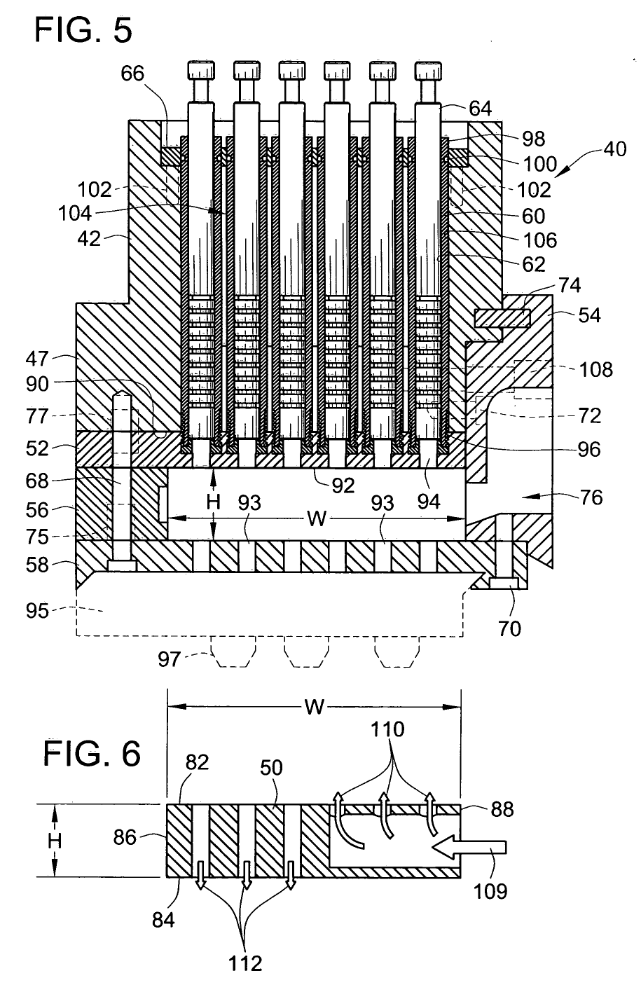

As shown in FIG. 6, the valve bar is rectangular in cross section, and has generally parallel upper and lower surfaces 82, 84 thereof joined by oppositely facing left and right side surfaces 86, 88 thereof, with the upper, lower and side surfaces 82, 84, 86, 88 of the valve bar 50 defining a height H and a width W of the valve bar 50. As shown in FIG. 5, the slot 48, defined by the valve guide apparatus 46, has a rectangular cross section having a height H and width W substantially matching the height H and width W of the valve bar 50.

As shown in FIG. 5, the pump body 42 defines a lower surface 90 thereof. The upper guide plate 52 is adapted for operative attachment to the lower surface 90 of the pump body 42 and defines a lower surface 92 of the upper guide plate 52 that is adapted for operatively mating with the upper surface 82 of the valve bar 50.

The upper guide plate 52 also defines a plurality of outlet orifices 93 for providing fluid communication between the cylinder bore 62 of each of the cylinders 60, and the slot 48 in the valve guide apparatus 46. The lower end 96 of each cylinder 60 is threaded to engage a mating thread in a respective through-hole 94, for attaching the cylinders 60 to the upper guide plate 52 in a manner that forms a sealed flow path from the slot 48 into each of the cylinder bores 62, for the measured volumes of liquefied candy mixture that are pulled up into the cylinder bores 62 during operation of the depositor pump 40.

The lower guide plate 58 of the valve guide apparatus 46 defines a plurality of outlet orifices 93, for directing the measured volume of liquefied candy mixture, through nozzles 97 of a nozzle plate 95 attached to the lower guide plate 58, into cavities 34 in a starch filled tray 36, positioned beneath the depositor pump 40.

The upper end 98 of each of the cylinders 60 is attached to the removable cylinder support plate 66, with a joint sealed by an O-ring (not shown) disposed in an annular groove 100 of the cylinder. The removable support plate 66 is attached to the valve body 42 with several screws, as shown at 102.

With the removable support plate 66 and upper guide plate 52 attachment to the pump body in the manner described above, a common closed plenum 104 is created within the interstitial spaces between the cylinders 60 in the valve body 42, bounded by radially outer surfaces of the cylinders 60, an inner wall surface 106 of the pump body 42, a lower surface of the removable cylinder support plate 66 and an upper surface of the upper guide plate 52. Inlet and outlet ports are provided, as indicated at 108, for providing a flow of hot or cold water through the plenum 104 and around the cylinders 60, for providing heating or cooling during operation of the depositor pump 40.

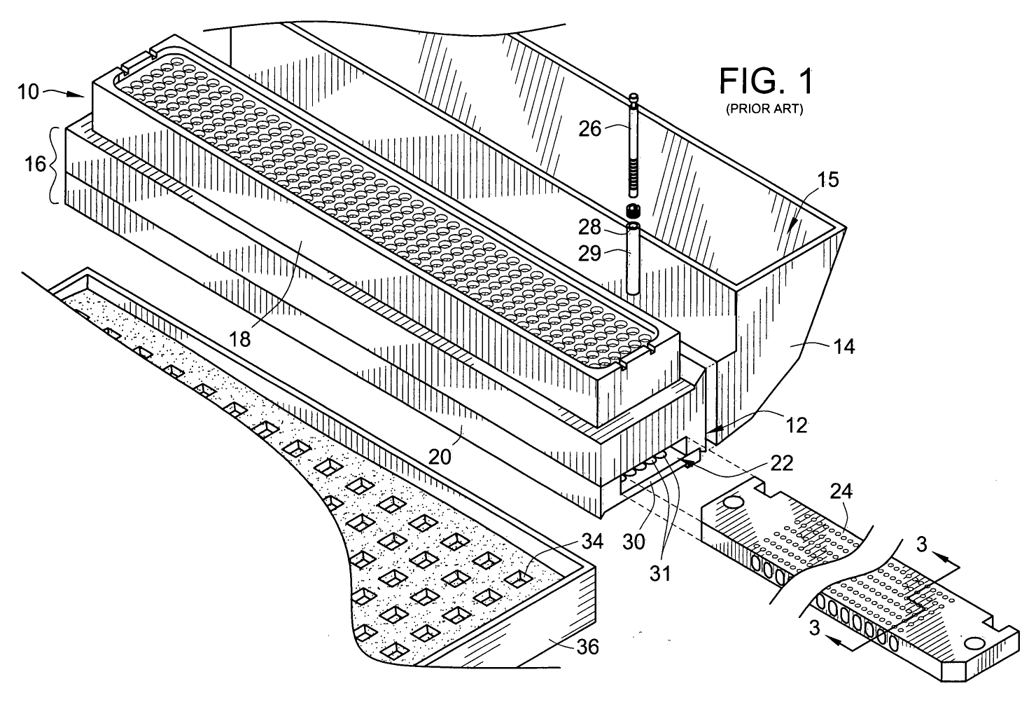

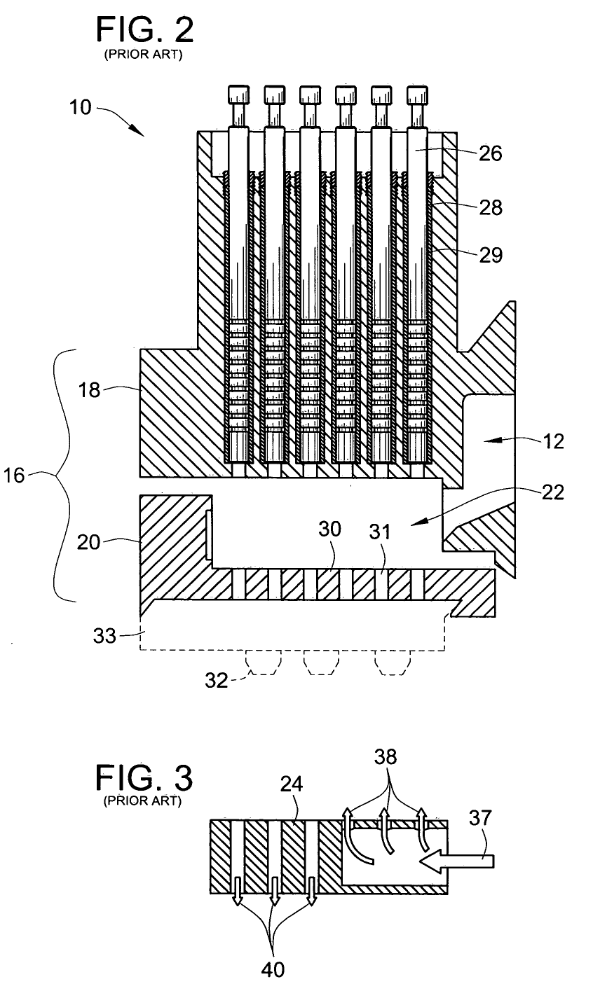

The internal construction of the valve bar 50 is essentially identical to the valve bar 24 of the prior depositor pump 10 described above with reference to FIGS. 1-3. As shown in FIG. 6, the valve bar 50, of the modular valve apparatus 44 includes a large number of internal passageways, arranged in longitudinally offset arrays, for receiving the liquefied candy mixture, as indicated at 109, and directing it along either a first path 110 from the inlet 76 to the cylinder bores 62, or a second path 112 from the cylinder bores 62 to the nozzles 97, depending upon whether the valve bar 50 is in a first or a second position in the longitudinally extending rectangular shaped slot 48 formed by the valve guide apparatus 44.

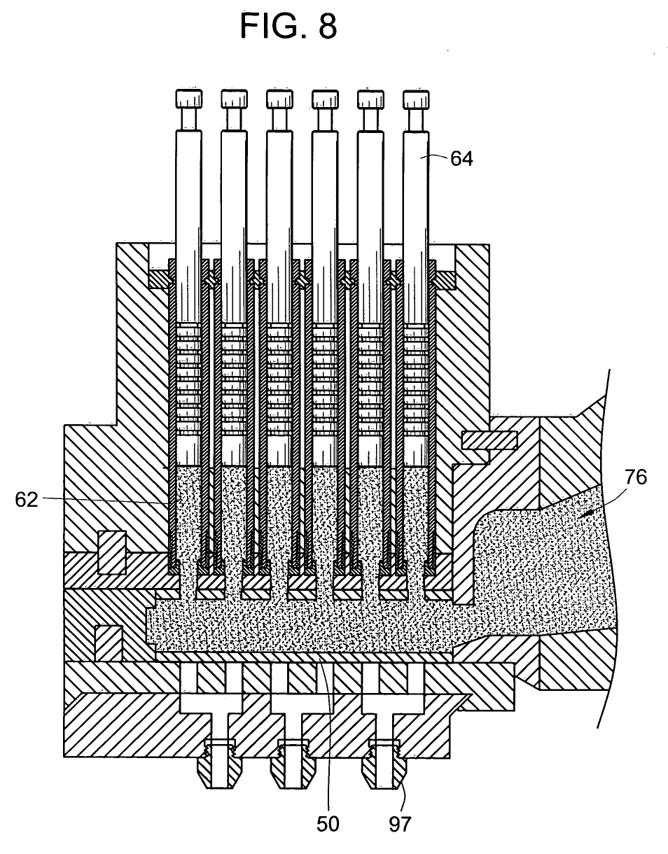

The valve bar 50 is shuttled between the first and second positions, and the pistons 64 are reciprocated in unison in the cylinder bores 62, in a timed relationship, such that when the valve bar 50 is in the first position, as shown in FIG. 8, a measured amount of liquefied candy mixture can be drawn into each of the cylinder bores 62 from the inlet 76, along the first path 110 through one set of internal passageways in the valve bar 50, by an upward motion of the pistons 64. With the valve bar 50 in the first position, the valve bar 50 cuts off any fluid communication between the cylinder bores 62 and the nozzles 97.

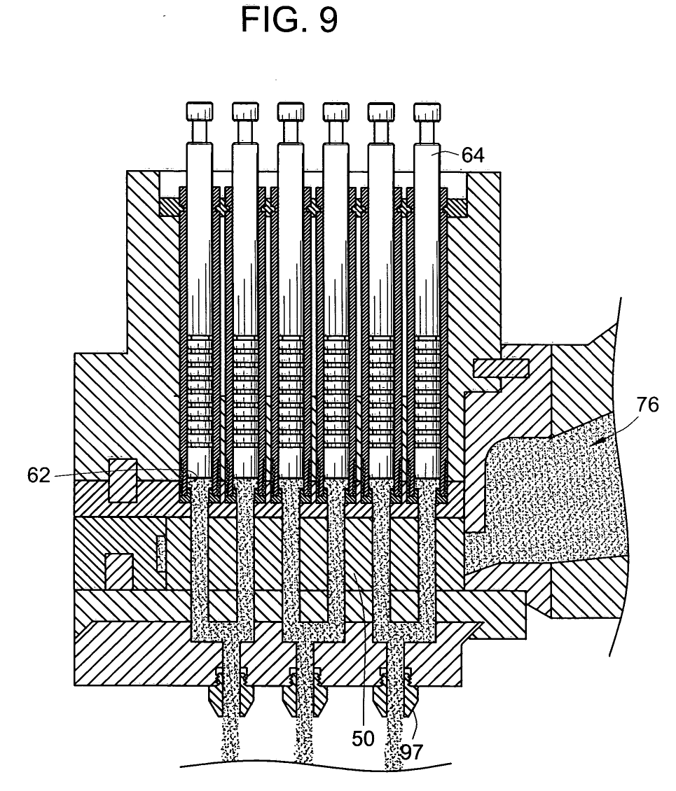

Once the desired amount of liquefied candy mixture has been drawn into the cylinder bores 62, the valve bar 50 is shuttled to the second position. As shown in FIG. 9. In the second position, the valve bar 50 cuts off fluid communication between the inlet 76 and the cylinder bores 62, so that no further liquefied candy can enter the cylinder bores 62 from the inlet 76, and so that the liquefied candy in the cylinder bores 62 cannot flow back out through the inlet 76. The second set of internal passageways 112 in the valve bar 50, provides fluid communication between the cylinder bores 62 and the nozzles 97. With the valve bar 50 in the second position 112, the pistons 64 are moved downward in the cylinder bores 62 to force the measured amounts of liquefied candy mixture in the cylinder bores 62 out through the nozzles 97 and into the cavities 34 in the starch mixture in the tray 36 positioned under the pump 10, as shown in FIGS. 4 and 9.

From the foregoing description of exemplary embodiments, those having skill in the art will recognize that the invention provides significant advantages in both initial fabrication of a depositor pump and its components, and in refurbishment of such a pump and components. The invention eliminates the need for difficult machining operations that were required in the past to produce the L-shaped sealing surfaces on the pump body and L-shaped valve guide of the housing. The modularity of the components of a valve guide apparatus and/or a depositor pump, according to the invention, allow the parts to be pre-machined and inventoried, so that when a pump needs to be refurbished some or all of the parts that touch the liquefied candy can be readily replaced on the pump body, without machining of the pump body, thereby allowing the refurbished pump to be quickly put back into service. The invention also allows the pump body to be readily manufactured from bar stock, rather than from a large and expensive casting of the type typically used in prior pumps with L-shaped sealing surfaces.

The foregoing description of exemplary embodiments of the invention has been presented for purposes of illustration and description. It is not intended to be exhaustive or to limit the invention to the precise embodiments disclosed. Numerous modifications or variations are possible in light of the above teachings. For example, a modular valve apparatus, according to the invention, may include some or all of the components shown in FIG. 7, and may also include additional components. The embodiments disclosed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A modular valve apparatus, for a depositor pump having a pump body, the modular valve apparatus comprising:
a valve guide apparatus adapted for attachment to the pump body, and defining a slot therein for receiving a valve bar; and
a valve bar adapted for sliding operation within the slot.

2. The modular valve apparatus of claim 1, wherein the valve guide apparatus further defines a pump inlet in fluid communication with the slot of the valve guide apparatus.

3. The modular valve apparatus of claim 1, wherein:
the valve bar is rectangular in cross section having generally parallel upper and lower surface thereof joined by oppositely facing side surfaces thereof, the upper lower and side surfaces of the valve bar defining a height and a width of the valve bar; and
the slot defined by the valve guide apparatus has a rectangular cross section having a height and width substantially matching the height and width of the valve bar.

4. The modular valve apparatus of claim 3, wherein the pump body defines a lower surface thereof, and the valve guide apparatus comprises;
an upper guide plate adapted for operative attachment to the lower surface of the pump body and defining a lower surface of the upper guide plate adapted for operatively mating with the upper surface of the valve bar.

5. The modular valve apparatus of claim 4, wherein the depositor pump includes a cylinder bore and the upper guide plate defines a through hole for providing fluid communication between the cylinder bore and the slot in the valve guide apparatus.

6. The modular valve apparatus of claim 5, wherein the cylinder bore is defined by a cylinder having a lower end thereof, and the through hole of the upper guide plate is adapted to operatively receive the lower end of the cylinder.

7. The modular valve apparatus of claim 6, wherein the cylinder includes an upper end thereof, and the modular valve apparatus further includes a removable cylinder support plate adapted for operatively connecting the upper end of the cylinder to the pump body.

8. The modular valve apparatus of claim 7, wherein the top plate and upper guide plate are adapted for attachment to the pump body in a manner creating a common closed plenum bounded by the cylinder, the pump body, the removable cylinder support plate and the upper guide plate.

9. The modular valve apparatus of claim 7, further comprising the cylinder.

10. The modular valve apparatus of claim 4, wherein the valve guide apparatus further comprises:
a lower guide plate defining an upper surface of the lower guide plate adapted for operatively mating with the lower surface of the valve bar; and
an inlet manifold adapted for operative attachment between the lower guide plate and the valve body, and defining a pump inlet in fluid communication with the slot.

11. The modular valve apparatus of claim 4, wherein the valve guide apparatus further comprises:
a lower guide plate defining an upper surface of the lower guide plate adapted for operatively mating with the lower surface of the valve bar; and
a side rail adapted for operatively connecting the upper and lower guide plates in a spaced relationship with one another, separated from one another by the height of the slot.

12. The modular valve apparatus of claim 11, further comprising an inlet manifold adapted for operative attachment between the lower guide plate and the valve body, and defining a pump inlet in fluid communication with the slot.

13. A depositor pump, comprising:
a pump body; and
a modular valve apparatus operatively attached to the pump body.

14. The depositor pump of claim 13, wherein the modular valve apparatus comprises:
a valve guide apparatus attached to the pump body, and defining a slot therein for receiving a valve bar; and
a valve bar disposed for sliding operation within the slot.

15. The depositor pump of claim 14, wherein the valve guide apparatus further defines a pump inlet in fluid communication with the slot of the valve guide apparatus.

16. The depositor pump of claim 14, wherein:
the valve bar is rectangular in cross section having generally parallel upper and lower surface thereof joined by oppositely facing side surfaces thereof, the upper lower and side surfaces of the valve bar defining a height and a width of the valve bar; and
the slot defined by the valve guide apparatus has a rectangular cross section having a height and width substantially matching the height and width of the valve bar.

17. The depositor pump of claim 16, wherein the pump body defines a lower surface thereof, and the valve guide apparatus comprises;
an upper guide plate operatively attached to the lower surface of the pump body and defining a lower surface of the upper guide plate operatively mating with the upper surface of the valve bar.

18. The depositor pump of claim 17, wherein the depositor pump includes a cylinder bore and the upper guide plate defines a through hole for providing fluid communication between the cylinder bore and the slot in the valve guide apparatus.

19. The depositor pump of claim 18, wherein the cylinder bore is defined by a cylinder having a lower end thereof, and the through hole of the upper guide plate operatively receives the lower end of the cylinder.

20. The depositor pump of claim 19, wherein the cylinder includes an upper end thereof, and the modular valve apparatus further includes a removable cylinder support plate operatively connecting the upper end of the cylinder to the pump body.

21. The depositor pump of claim 20, wherein the top plate and upper guide plate are attached to the pump body in a manner creating a common closed plenum bounded by the cylinder, the pump body, the removable cylinder support plate and the upper guide plate.

22. The depositor pump of claim 17, wherein the valve guide apparatus further comprises:
a lower guide plate defining an upper surface of the lower guide plate operatively mating with the lower surface of the valve bar; and
an inlet manifold operatively attached between the lower guide plate and the valve body, and defining a pump inlet in fluid communication with the slot.

23. The depositor pump of claim 17, wherein the valve guide apparatus further comprises:
a lower guide plate defining an upper surface of the lower guide plate operatively mating with the lower surface of the valve bar; and
a side rail operatively connecting the upper and lower guide plates in a spaced relationship with one another, separated from one another by the height of the slot.

24. The depositor pump of claim 23, further comprising an inlet manifold operatively attached between the lower guide plate and the valve body, and defining a pump inlet in fluid communication with the slot.

25. A depositor pump, comprising:
a pump body; and
a modular valve apparatus operatively attached to the pump body;
the modular valve apparatus including a valve guide apparatus attached to the pump body, and defining a slot therein for receiving a valve bar.

26. The depositor pump of claim 25, wherein the valve guide apparatus comprises, an upper guide plate and an inlet manifold attached to the pump body, a side rail attached to the upper guide plate, and a lower guide plate attached to the inlet manifold and the side rail, with the upper and lower guide plates, the side rail, and the inlet manifold, in combination, defining the slot for receiving a valve bar.
